(19) United States
(12) Patent Application Publication
(10) Pub. No.: US 2012/0284348 A1
(43) Pub. Date: Nov. 8, 2012

(54) SYSTEM AND METHOD FOR SOCIAL INTERACTIVITY WHILE USING AN E-BOOK READER

(75) Inventor: Leigh M. Rothschild, Sunny Isles Beach, FL (US)

(73) Assignee: Ariel Inventions LLC, Sunny Isles Beach, FL (US)

(21) Appl. No.: 13/464,985

(22) Filed: May 5, 2012

Related U.S. Application Data
(60) Provisional application No. 61/483,012, filed on May 5, 2011.

(51) Int. Cl. G06F 15/16

(52) U.S. Cl. 709/206

(57) ABSTRACT

Embodiment of the disclosure may include methods, systems, and devices of interacting with digital media on an electronic book (e-book) reader. Embodiments include presenting e-book content on a first mobile device as receiving input from a first user based on the e-book content on the first mobile device. Further, an electronic message is generated based on the input from the first user. In addition, the electronic message is transmitted with associated identification information of the first mobile device, and an e-book content identifier to a remote media computer server through a communication network. Moreover, the electronic message is received with associated identification information of the first mobile device and the e-book content identifier by the remote media computer server which determines a set of third party mobile devices having the e-book content based on the e-book content identifier. The electronic message is transmitted to each third party mobile devices.

### CROSS-REFERENCE TO RELATED APPLICATIONS

The present application claims priority under the laws and rules of the United States, including 35 USC §120, to U.S. Provisional Patent Application No. 61/483,012 filed on May 5, 2011. The contents of U.S. Provisional Patent Application No. 61/483,012 are herein incorporated by reference.

### BACKGROUND

Various companies produce and distribute electronic book readers (“e-book readers”). Examples of popular readers include the Apple iPad, Amazon Kindle, and the Barnes and Noble Nook among others. E-book readers allow users to page through and read digital content on either a black and white or color display device. The devices also allow users to perform local searches (such as dictionary search) of the local content, and in some cases to do a Web (Internet) search of the content. E-book readers currently do not allow a user to interact with other users having the same e-book content.

Alternatively, social media websites allow users to add content to a media server so that other users can read and add their own comments regarding the new content. Users of the social media website are able to view, comment, and add content as they wish, which is gathered centrally on a remote media computer server of the social media website. Some of the content that is added includes comments, queries, and hyperlinks as well as other types of content. This type of technical architecture is used in a variety of social media websites including, Facebook, Twitter, LinkedIn, and MySpace among others.

### SUMMARY

Embodiments of the present disclosure include enhancing both e-book and social media technologies of e-books and social media websites such that a user can correspond with other users having the same e-book content. Such a feature allows users to pose queries, comments, and hyperlinks containing information regarding the e-book content. Modifying the traditional technical architecture of social media would allow e-book users having the same e-book content to interact with each other. The present disclosure describes devices, systems, and methods that allow a first user to generate an electronic message regarding e-book content through a first user mobile device and sends the electronic message to a remote media computer server along with first user device and e-book identifying information. Further, the remote media computer server determines third party devices having the same content and then sends the electronic message to such third party user devices. In addition, one or more third party users having the e-book content can generate a response electronic message to the first user's electronic message that is relayed by the remote media computer server to the first user device.

Embodiments of the present disclosure include a method of interacting with digital media on an electronic book (e-book) reader. The method may include presenting e-book content on a display of a first mobile device using an e-book reader application as well as receiving input from a first user based on the e-book content on the first mobile device through a user interface. A further step may be generating an electronic message using the first mobile device based on the input from the first user. An additional step may include transmitting the electronic message and associated identification information of the first mobile device, and an e-book content identifier to a remote media computer server through a communication network.

Moreover, other steps may include receiving the electronic message and associated identification information of the first mobile device and the e-book content identifier by the remote media computer server as well as determining a set of third party mobile devices having the e-book content based on the e-book content identifier. Another step may be transmitting the electronic message to each third party mobile devices to be presented on the display of each third party mobile device.

The electronic message can be selected from the group consisting of at least one of comments, queries, and hyperlinks to other information sources across the communication network. Further, a first set of instructions are provided by the first mobile device when transmitting the electronic message to the remote media computer server, the first set of instructions limiting the set of third party mobile devices to a geographic location. In addition, a second set of instructions are provided by the first mobile device when transmitting the electronic message to the remote media computer server, the second set of instructions directing the remote media computer server to transmit the electronic message to the author of the e-book content.

Further steps may include receiving and causing to display the electronic message using the display module on at least one of the third party mobile devices as well as storing the electronic message, associated identification information of the first user mobile device, and the e-book identifier on the remote media computer server. An additional step may include storing the electronic message on a storage device of the first user mobile device and a storage device on at least one of each of the third party mobile devices. The storage device on the first user mobile device and the third party user devices can be selected from a group consisting of at least one of an internal storage device and a removable storage device. Moreover, the display module of the first user mobile device and the display module for the third party mobile devices are capable of presenting and hiding the information displayed on the respective mobile device.

Further steps in the method may include generating a response electronic message by one of the third party mobile devices as well as receiving the response electronic message by the remote media computer server. An additional step may include transmitting, by the remote media computer server, the response electronic message to the first mobile device based on the associated identification information of the first mobile device. Other steps include receiving the response electronic message on the first user mobile device and displaying the response electronic message on the first user mobile device.

The first user mobile device and the third party mobile devices can be selected from the group consisting of at least one of iPad, iPhone, Blackberry, Androids, Kindle, Nook, Sony Reader, BeBook Neo, and any other device that implements an electronic reading software program.

Embodiments of the present disclosure include a system of interacting with digital media in an electronic book (e-book) reader using a remote network website. The system includes a first user mobile device having a device display module configured to present e-book content on the display of the first mobile device using an electronic book reader application as well as a device input module configured to receive input from the first user based on the e-book content on the first user mobile device through a user interface. The first user mobile device also includes a device messaging module for generating at least one electronic message on the first user mobile device based on the input from the first user and a device communication module configured to transmit the electronic message, the associated identification information of the first user mobile device, and an e-book content identifier to a remote media computer server through a communication network.

The system also includes a remote media computer server having a server communication module configured to receive the electronic message, associated identification information of the first user mobile device, and the e-book content identifier by the remote media computer server as well as a server processing module configured to determine a set of third party mobile devices having the e-book content based on the e-book content identifier. Further, the server communication module transmits the electronic message to each of the third party mobile devices to be presented on the display of each third party mobile device.

In addition, a first set of instructions are provided by the first mobile device when transmitting the electronic message to the remote media computer server, the first set of instructions limiting the set of third party mobile devices to a geographic location. Further, a second set of instructions are provided by the first mobile device when transmitting the electronic message to the remote media computer server, the second set of instructions directing the remote media computer server to transmit the electronic message to the author of the e-book content.

The remote media computer server also include a server storage module configured to store the electronic message, associated identification information of the first user mobile device, and the e-book content identifier on the remote media computer server. Moreover, the first user device display module is capable of presenting and hiding the information displayed on the first user mobile device.

The system also includes a third party mobile device having a third party device communication module configured to receive the electronic message from the remote media computer server as well as a third party device input module configured to receive input from a third party user based on the electronic message through a user interface and a third party device messaging module for generating a response electronic message. The third party device communication module configured to transmit the response electronic message to the remote media computer server.

Moreover, the server communication module is configured to receive the response electronic message from the third party user mobile device, a server storage module stores the response electronic message generated by the third party mobile device, and the server communication module is configured to transmit the response electronic message by a third party user to the first user mobile device associated identification information of the first user mobile device.

Further, the device communication module is configured to receive the response electronic message on the mobile device of the first user, the device storage module is configured to store the response electronic message on the first user mobile device of the first user, and device display module is configured to display the response electronic message on the first user mobile device.

The system further includes a first user device storage module to store the electronic message on the first user mobile device and a third party device storage module to store the electronic message on each of the third party mobile devices. The first user device storage module and the third party device storage modules each can be selected from the group consisting of an internal storage device or a removable storage device.

Embodiments of the present disclosure include a server for interacting with digital media in an electronic book (e-book) reader. The server includes a server communication module configured to receive the electronic message, associated identification information of the first user mobile device, and the e-book content identifier by the remote media computer server, and a server processing module configured to determine a set of third party mobile devices having the e-book content based on the e-book content identifier. The server communication module transmits the electronic message to each of the third party mobile devices to be presented on the display of each third party mobile device.

The server further includes a server storage module configured to store the electronic message, associated identification information of the first user mobile device, and the e-book content identifier on the remote media computer server. In addition, the server communication module receives a first set of instructions from the first mobile device, the first set of instructions limiting the set of third party mobile devices to a geographic location. Moreover, the server communication module receives a second set of instructions from the first mobile device, the second set of instructions directing the server to transmit the electronic message to the author of the e-book content.

Further, the server communication module is configured to receive the response electronic message from the third party user mobile device, a server storage module stores the response electronic message generated by the third party mobile device, and the server communication module is configured to transmit the response electronic message by a third party user to the first user mobile device based on the associated identification information of the first user mobile device.

Note, term “module” (e.g. communications module) may include either hardware components (e.g. hard ware communication interfaces) or software applications (e.g. communication software applications) or a combination thereof and is not limiting.

### BRIEF DESCRIPTION OF THE SEVERAL VIEWS OF THE DRAWINGS

The accompanying drawings, which are incorporated in and constitute part of this specification, illustrate embodiments of the invention and together with the description serve to explain the principles of the present disclosure. The embodiments illustrated herein are presently preferred, it being understood, however, that the invention is not limited to the precise arrangements and instrumentalities shown, wherein:

FIG. 1 is a network diagram of an exemplary system illustrating aspects of the present disclosure;

FIG. 2 is a functional block diagram of an exemplary mobile device illustrating aspects of the present disclosure;

FIG. 3 is a functional block diagram of an exemplary remote media computer server illustrating aspects of the present disclosure; and

FIGS. 4A-D are flowcharts of an example method illustrating aspects of the present disclosure.

### DETAILED DESCRIPTION

The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein. Further, in the foregoing description, numerous details are set forth to further describe and explain one or more embodiments. These details include system configurations, block module diagrams, flowcharts (including transaction diagrams), and accompanying written description. While these details are helpful to explain one or more embodiments of the disclosure, those skilled in the art will understand that these specific details are not required in order to practice the embodiments.

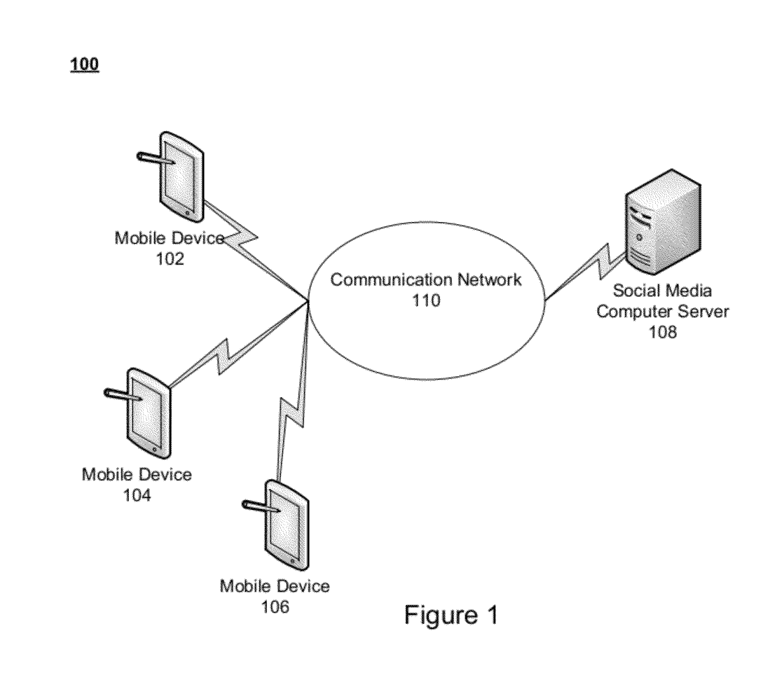

FIG. 1 is an exemplary network diagram 100 illustrating aspects of the present disclosure. A mobile device 102 communicates with a remote media computer server 108 over a communication network 110. Further, the remote media computer server 108 may be coupled to third party mobile devices (104 and 106) over the communication network 110. Each of the mobile devices (102, 104, and 106) may be an electronic book (e-book) reader and/or a mobile device having e-book reading software. Mobile device 102 presents e-book content using an electronic book reader software application to a first user. The first user may have a query or comment regarding the e-book content and inputs such query or comment into the mobile device 102 through a user interface. Further, the mobile device 102 generates an electronic message to include the query or comment to be transmitted over the communication network 110 to the remote media computer server 108. In addition to the electronic message, the mobile device 102 also transmits identifying information regarding the e-book content as well as the mobile device 102. Further, the mobile device 102 may include a global positioning system (GPS). Thus, the identifying information regarding the mobile device 102 may also include locational information provided by the GPS. The remote media computer server 108 then receives the electronic message from the mobile device 102, which determines a set of third party mobile devices (104 and 106) having the e-book content based on the e-book content identifying information sent by the first user. Accordingly, the remote media computer server 108 sends the electronic message to those third party mobile devices (104 and 106).

The third party devices (104 and 106) receive the electronic message and present the electronic message on the display of their respective mobile devices (104 and 106). One or more third party users, upon viewing the electronic message, may input a response to the electronic message on their respective mobile device (104 and 106) thereby generating a response electronic message based on the third party user input. The third party mobile device (104 and 106) transmits the response electronic message to the remote media computer server 108. Further, the remote media computer server 108 transmits the response electronic message to the first user's mobile device 102 based on the first user mobile device identifying information received previously. Upon receipt, the first user mobile device 102 presents the response electronic message on the display of the first user mobile device 102.

For example, a first user of mobile device 102 is reading the e-book Angels & Demons by Dan Brown. While reading the e-book content, the first user may want to query third party users currently reading same e-book content. The user may like to ask a question about a certain location described in e-book content (e.g. “Famous church in Vatican City”). The user may input the query into the mobile device 102 which generates an electronic message based on the query and then sends the electronic message to the remote media computer server 108 over the communication network 110. In addition to the electronic message, the mobile device 102 may also send identifying information regarding the mobile device 102 including locational information and the e-book content.

Upon receipt, the remote media computer server 108 performs a search of third party mobile devices 104 having the same e-book content based on the e-book identifying information. Further, the remote media computer server 108 sends the electronic message to a set of third party mobile devices (104 and 106). The third party mobile devices (104 and 106) receive the electronic message, and each third party device presents the electronic message on their respective displays. Accordingly, a third party user viewing the electronic message may input a response (e.g. “St. Peter's Basilica”) on its third party mobile device (104 and 106) and generates a response electronic message that is sent to the remote media computer server 108. Further, the remote media computer server 108 relays the response electronic message to the first user mobile device 102 based on the previously received first user mobile device identifying information.

Persons of ordinary skill in the art would understand that communication network 110 may incorporate various technologies including, but not limited to, cellular (3G, 4G, CDMA, SM, GPRS, etc.), WiFi communications (IEEE 802.11-b, g, k, n, etc.), cable, infrared, and satellite, or any other communication technology known in the art or combination of the above.

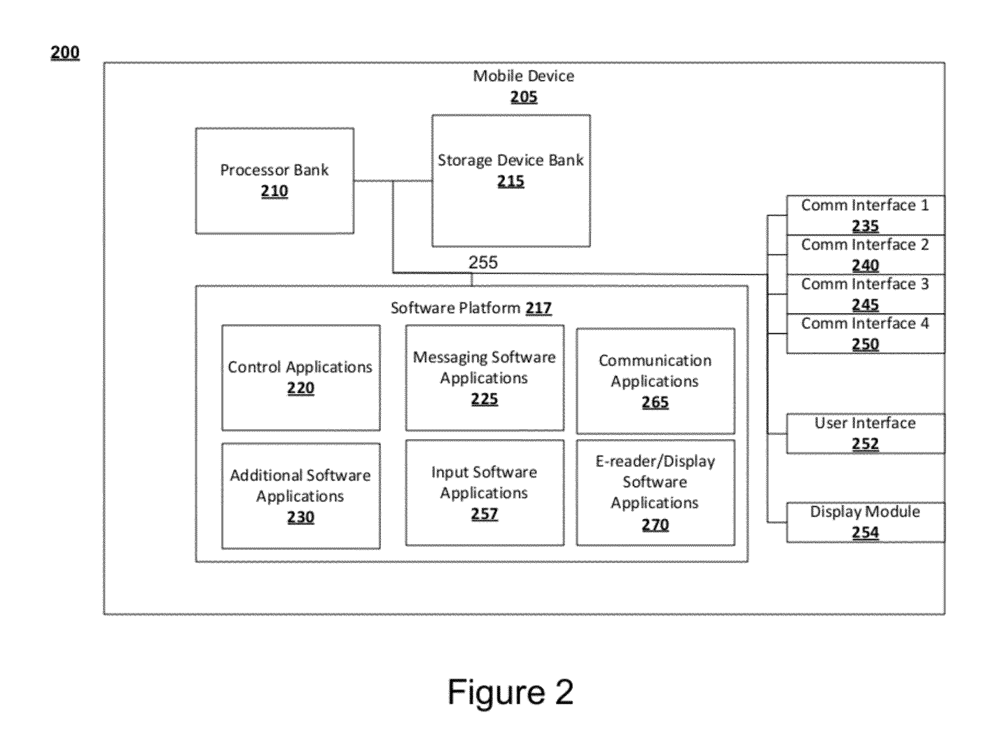

FIG. 2 is an exemplary functional block diagram 200 of a mobile device 205 illustrating aspects of the present disclosure. The mobile device 205 includes, but is not limited to, a processor bank 210, a storage device bank 215, a software platform 217, one or more communication interfaces (235-250), a user interface 252, and a display module 254.

The processor bank 210 may include one or more processors that may be co-located with each other or may be located in different parts of the mobile device 205. The storage device bank 215 may include one or more storage devices. Types of storage devices may include memory devices, electronic memory, optical memory, internal storage media, and/or removable storage media. The one or more software applications 217 may include a control applications 220, additional software applications 230, messaging software applications 225, input software application 257, communication applications 265 and electronic reader/display software applications 270. Further, the control and additional software applications 220 and 230 may include control software applications that implement software functions that assist in performing certain tasks for the mobile device 205 such as providing access to a communication network, executing an operating system, managing software drivers for peripheral components, and processing information. In addition, the control and additional software applications 220 and 230 may also include software drivers for peripheral components, user interface computer programs, debugging and troubleshooting software tools. Also, the control and additional software applications 220 and 230 may include an operating system supported by the remote server. Such operating systems are known in the art for such a remote server but may also include computer and smartphone operating systems (e.g. Windows 7, Linux, Android, IOS UNIX, previous version of Windows and MacOS, etc.).

Other software applications (225, 257, 265, and 270) of the software platform 217 of the mobile device 205 include the e-reader/display software applications 270. Further, e-reader/display software applications interacts with the processor bank 210 and the storage bank 215 to retrieve e-book content and cause the e-book content to be presented on the display of the mobile device 205 using the display module 254. While viewing the e-book content, a user of mobile device 205 may like to enter a query to other users regarding the e-book content. The user may input such a query using the user interface 252 of the mobile device 205, for example, a web browser or some other graphical user interface. The input software applications 257 may include may include the web browser or other graphical user interface. Alternatively, the input software application 257 may be voice recognition technology that allows the mobile device 205 to receive voice input. In addition, the input software applications 257 may include gesture recognition or touchscreen technology that recognize user gestures or touch as input.

The messaging software applications 225 generate an electronic message based on the received user input. Such an electronic message is relayed to the communication applications 265 whereby the electronic message is transmitted to a remote media computer server over a communication network along with identifying information of the mobile device 205 as well as an e-book content identifier. Further, the mobile device 205 may include a global positioning system (GPS) (not shown). Thus, the identifying information regarding the mobile device 205 may also include locational information provided by the GPS. The communications applications 265 transmit over one or more communication interfaces (235-250). The communication applications 265 may also receive a response electronic message through communication interfaces (235-250) and provides such a response electronic message to the messaging software applications 225 which, after processing the response relays it to the e-reader/display software applications 270. Further, the e-reader/display software applications 270 presents the response electronic message on the display of the mobile device 205 using display module 254. In addition, e-reader/display software applications 270 and the display module 254 allows the user to hide or show the response or any other electronic message regarding the e-book content.

Each of the communication interfaces (235-250) shown in FIG. 2 may be software, firmware or hardware associated in communicating to other devices. The communication interfaces (235-250) may be of different types that include a user interface, USB, Ethernet, WiFi, WiMax, wireless, optical, cellular, or any other communication interface coupled to a communication network.

An intra-device communication link 255 between the processor bank 210, storage device bank 215, software platform 217, and communication interfaces (235-250) may be one of several types that include a bus or other communication mechanism.

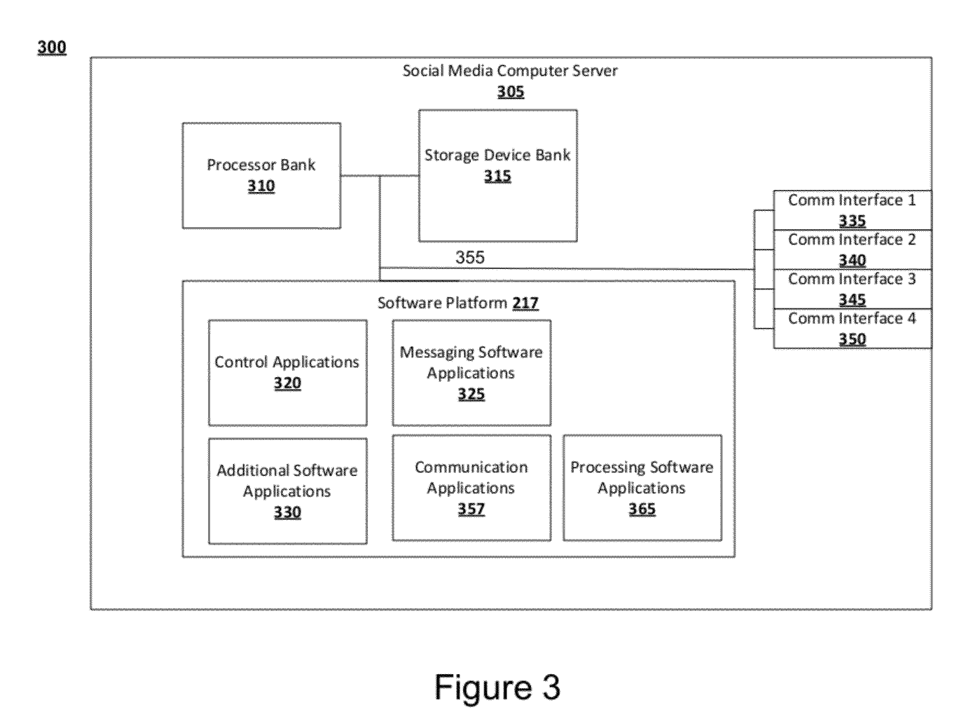

FIG. 3 is an exemplary functional block diagram 300 of a remote media computer server 305 illustrating aspects of the present disclosure. The remote media computer server 305 includes, but is not limited to, a processor bank 310, a storage device bank 315, a software platform 317, and one or more communication interfaces (335-350).

The processor bank 310 may include one or more processors that may be co-located with each other or may be located in different parts of the remote media computer server 305. The storage device bank 315 may include one or more storage devices. Types of storage devices may include memory devices, electronic memory, optical memory, internal storage media, and/or removable storage media. The one or more software platform 317 may include control applications 320, additional software applications 330, messaging software applications 325, communication applications 357 and processing software applications 365. Further, the control and additional software applications 320 and 330 may include control software applications that implement software functions that assist in performing certain tasks for the remote media computer server 305 such as providing access to a communication network, executing an operating system, managing software drivers for peripheral components, and processing information. In addition, the control and additional software applications 320 and 330 may also include software drivers for peripheral components, user interface computer programs, debugging and troubleshooting software tools. Also, the control and additional software applications 320 and 330 may include an operating system supported by the remote server. Such operating systems are known in the art for such a remote server but may also include computer and smartphone operating systems (e.g. Windows 7, Linux, Android, IOS UNIX, previous version of Windows and MacOS, etc.).

Other software applications (325, 357, and 365) of the software platform 317 of the remote media computer server 305 include the communications applications 357. Further, the communications applications receive and transmit electronic messages generated by mobile devices such as electronic readers over one or more communication interfaces (235-250). The communication applications 357 may also receive and transmit response electronic messages, which may be provided to the mobile device, through communication interfaces (235-250). The communication applications 257 may relay the received messages to the messaging software applications 325 and processing software applications 365. Messaging software applications 325 may store the received electronic message as well as the identifying information of the sending mobile device and e-book content in the storage bank 315. The processing software applications 365 may determine a set of third party user mobile devices that have the e-book content associated with the electronic message and relay such information to the communication applications 357 to send the electronic message to such mobile devices, accordingly. The remote media computer server 305 may store a record of the e-book content on each third party mobile device such that look up of the third party mobile devices may be straightforward during the processing of the e-book content identifying information. Alternatively, if the processing software applications 365 receives a response electronic message, the processing software applications 365 looks up the first user mobile device identifying information stored previously by the messaging software applications in to the storage bank 315.

Each of the communication interfaces (335-350) shown in FIG. 3 may be software, firmware or hardware associated in communicating to other devices. The communication interfaces (335-350) may be of different types that include a user interface, USB, Ethernet, WiFi, WiMax, wireless, optical, cellular, or any other communication interface coupled to a communication network.

An intra-device communication link 355 is provided between the processor bank 310, storage device bank 315, software platform 317, and communication interfaces (335-350) may be one of several types that include a bus or other communication mechanism.

### EXAMPLE 1

Referring to FIGS. 2 and 3, the mobile device may be any device that implements an electronic reading software program that includes, but is not limited to, Apple iPad or iPhone, Blackberry Smartphones, Android Smartphones, Amazon Kindle, Barnes & Noble Nook, Sony Reader, BeBook Neo, any other electronic readings device known in the art or a combination of the above. The mobile device 205 may allow a user to view any type of digital content (electronic books, Internet websites, documents, images, videos, etc.).

For example, the user may be reading the e-book Angels & Demons by Dan Brown using an Amazon Kindle electronic reader software application. The user may input a query regarding the e-book content and generates an electronic message based on the query. The input may include highlighting a section of the e-book content to include in the query (e.g. What is “a large church in the Vatican City?”). Further, the mobile device 205 then sends the electronic message to a remote media computer server owned or operated by Amazon along with identifying information of the first user mobile device (which may include locational information) and the e-book content. The remote media computer server may store the identifying information. Further the remote media computer server looks up records of the third party mobile devices that have purchased the particular e-book content (Angels & Demons) then relay the electronic message to such third party mobile devices.

Moreover, a third party mobile device may be online such that it receives the electronic message from the remote media computer server in real time. Alternatively, a third party mobile device may be offline such that the remote media computer server may send the electronic message to the third party device once it is detected to be online. Upon receipt of the electronic message, the third party mobile device may display the electronic message to the third party user. Further, the third party user may input a response such that the third party mobile device generates a response electronic message to be sent to the remote media computer server (e.g. St Peter's Basilica).

The remote media computer server receives the response electronic message and determines the first user mobile device based on the identifying information previously received. The remote media computer server then sends the response electronic message to the first user mobile device accordingly.

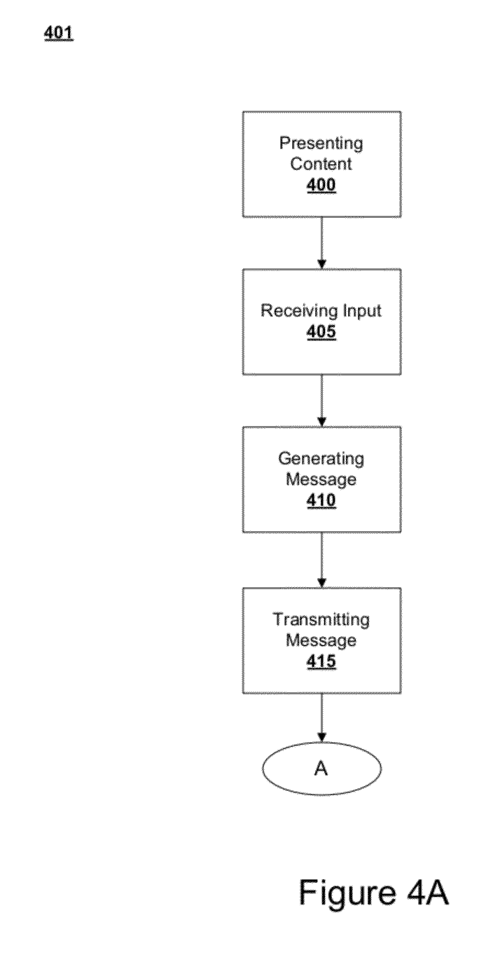

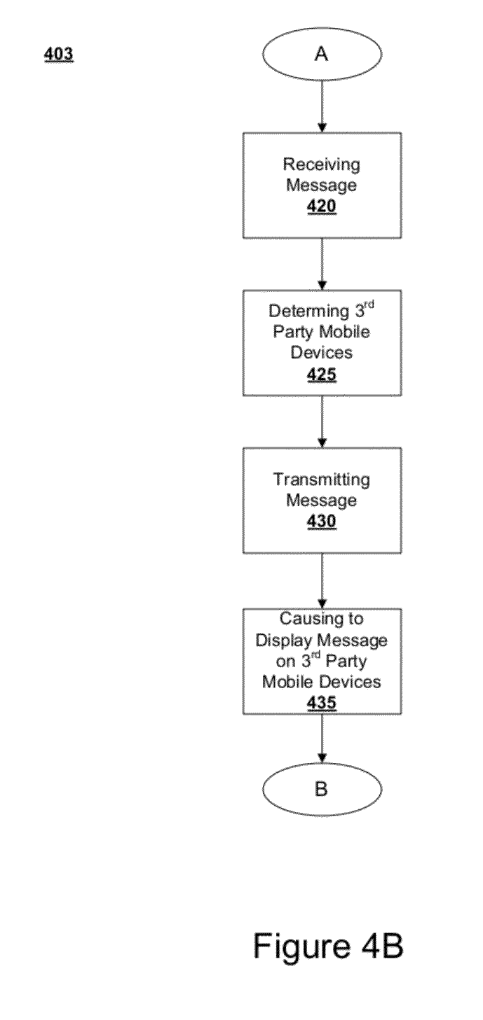

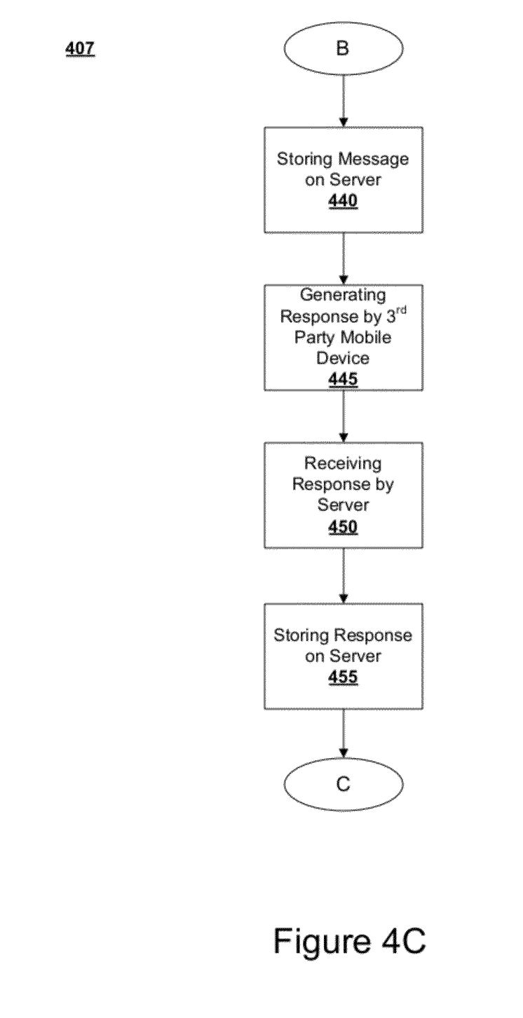

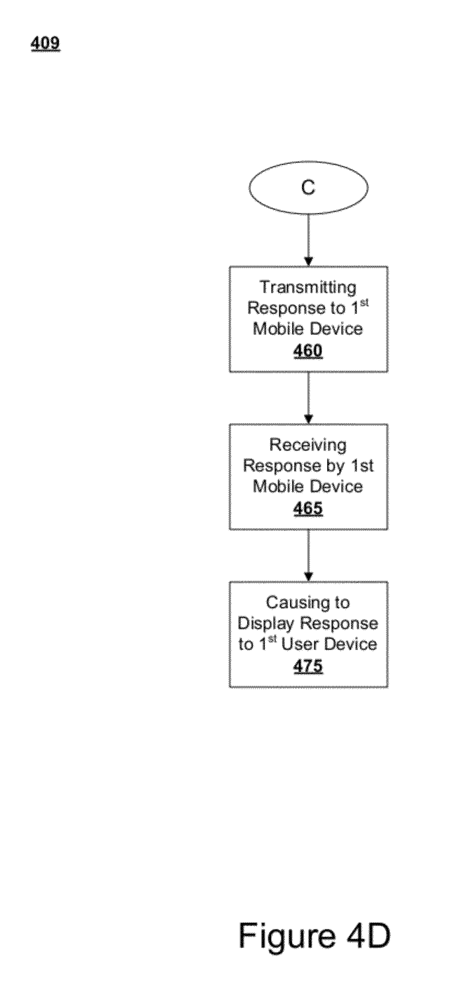

FIGS. 4A-D are flowcharts of an example method illustrating aspects of the present disclosure. Referring to FIG. 4A, a step in the example method may include presenting e-book content on a display of a first mobile device using an e-book reader application, as shown in block 400. Such e-book content may have been previously downloaded to the first mobile device from one of many e-book content providers. A further step in the method may be receiving input from a first user based on the e-book content on the first mobile device through a user interface, as shown in block 405. The input may include highlighting a section of the e-book content to include in the query. An additional step may be generating an electronic message using the first mobile device based on the input from the first user, as shown in block 410. Another step in the example method includes transmitting the electronic message and associated identification information of the first mobile device and an e-book content identifier to a remote media computer server through a communication network, as shown in block 415. The first mobile device may include a global positioning system (GPS). Thus, the identifying information regarding the first mobile device may also include locational information provided by the GPS.

Referring to FIG. 4B, a further step may be receiving the electronic message and associated identification information of the first mobile device and the e-book content identifier by the remote media computer server, as shown in block 420. An additional step may be determining a set of third party mobile devices having the e-book content based on the e-book content identifier, as shown in block 425. The remote media computer server has access to records of e-book content downloaded to third party mobile devices. Thus, the remote media computer server processes the records based on the e-book content identifier to determine the set of third party mobile devices that have the e-book content. Moreover, another step may be transmitting the electronic message to each third party mobile devices to be presented on the display of each third party mobile device, as shown in block 430. A third party mobile device may be online such that it receives the electronic message from the remote media computer server in real time. Alternatively, a third party mobile device may be offline such that the remote media computer server may send the electronic message to the third party device once it is detected to be online. The electronic message can be comments, queries, and hyperlinks to other information sources across the communication network. A further step in the example method may be receiving and causing to display the electronic message using the display module on at least one of the third party mobile devices, as shown in block 435. The display module of the first user mobile device and the display module for the third party mobile devices are capable of presenting and hiding the message information displayed on the respective mobile device

Referring to FIG. 4C, another step in the example method may be storing the electronic message, associated identification information of the first user mobile device, and the e-book identifier on the remote media computer server, as shown in block 440. Alternatively, the electronic message may be stored on a storage device of the first user mobile device and a storage device on each of the third party mobile devices. The storage device on the first user mobile device and the third party user devices can be internal storage device or a removable storage device. A further step in the method may be generating a response electronic message by one of the third party mobile devices, as shown in block 445. An additional step may be receiving the response electronic message by the remote media computer server, as shown in block 450. Another step may be storing the response electronic message on the remote media computer server, as shown in block 455.

Referring to FIG. 4D, a further step in the example method may be transmitting via the remote media computer server, the response electronic message to the first mobile device based on the associated identification information of the first mobile device, as shown in block 460. An additional step may be receiving the response electronic message on the first user mobile device, as shown in block 465. The first user mobile device may be online such that it receives the response electronic message from the remote media computer server in real time. Alternatively, the first user mobile device may be offline such that the remote media computer server may send the response electronic message to the first user device once it is detected to be online. Another step may be causing to display the response electronic message on the first user mobile device, as shown in block 475.

### EXAMPLE 2

Referring to FIGS. 1, 2, and 3, another embodiment of the present disclosure may include having a messaging software application associated with a social media website (e.g. Facebook, Twitter, etc.) that may be downloaded separately but works in conjunction with e-reader software application on a mobile device. Such a messaging software application uploads records of all the e-book content contained on the mobile device to the remote media computer server. Thus, when a first user inputs and comments on particular e-book content then generates and sends an electronic message to the remote media computer server, the electronic message is relayed to other social media website users that have the same e-book content. Such third party users may or may not be contacts of the first user. Sending to all users or only contacts may be parameter of the messaging software application configurable by the first user. Further, third party users may provide response electronic messages, thereby generating a comment “chain” on the social media website.

In further embodiments, the first user is capable of configuring such a messaging software application to direct the electronic message to a specific group of third party users. For example, the first user may direct the electronic message only to contacts on a social media website. Alternatively, the first user may direct the electronic message to third party users located in a specific geographic area. For example, the first user resides in San Francisco and directs the electronic message only to third party users residing in San Francisco. If such a parameter is configured by the first user, then the messaging software applications may provide such parameters or instructions when transmitting the electronic message, mobile device identifying information and the e-book content identifier to the remote media computer server.

In additional embodiments, a first user may be capable of providing a comment or query to the author of the e-book content via an electronic message. Thus, the first user may configure a parameter of the messaging software applications to direct the electronic message to the author and such a parameter or instruction is provided when transmitting the electronic message, mobile device identifying information and the e-book content identifier to the remote media computer server.

Persons of ordinary skill in the art would understand that e-reader devices, applications and e-book content are but one set of embodiments of the present disclosure. Other embodiments may include social interactivity between users viewing the same video content or digital image content across the Internet or through smart television systems and the like.

The foregoing is illustrative only and is not intended to be in any way limiting. Reference is made to the accompanying drawings, which form a part hereof. In the drawings, similar symbols typically identify similar components, unless context dictates otherwise.

Note that the functional blocks, methods, devices and systems described in the present disclosure may be integrated or divided into different combination of systems, devices, and functional blocks as would be known to those skilled in the art.

In general, it should be understood that the circuits described herein may be implemented in hardware using integrated circuit development technologies, or yet via some other methods, or the combination of hardware and software objects that could be ordered, parameterized, and connected in a software environment to implement different functions described herein. For example, the present application may be implemented using a general purpose or dedicated processor running a software application through volatile or non-volatile memory. Also, the hardware objects could communicate using electrical signals, with states of the signals representing different data.

It should be further understood that this and other arrangements described herein are for purposes of example only. As such, those skilled in the art will appreciate that other arrangements and other elements (e.g. machines, interfaces, functions, orders, and groupings of functions, etc.) can be used instead, and some elements may be omitted altogether according to the desired results. Further, many of the elements that are described are functional entities that may be implemented as discrete or distributed components or in conjunction with other components, in any suitable combination and location.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed:

1. A method of interacting with digital media on an electronic book (e-book) reader, the method comprising:
presenting e-book content on a display of a first mobile device using an e-book reader application;
receiving input from a first user based on the e-book content on the first mobile device through a user interface;
generating an electronic message using the first mobile device based on the input from the first user;
transmitting the electronic message and associated identification information of the first mobile device, and an e-book content identifier to a remote media computer server through a communication network;
receiving the electronic message and associated identification information of the first mobile device and the e-book content identifier by the remote media computer server;
determining a set of third party mobile devices having the e-book content based on the e-book content identifier; and
transmitting the electronic message to each third party mobile devices to be presented on the display of each third party mobile device.

2. The method of claim 1, wherein the electronic message can be selected from the group consisting of at least one of comments, queries, and hyperlinks to other information sources across the communication network.

3. The method of claim 1, wherein a first set of instructions are provided by the first mobile device when transmitting the electronic message to the remote media computer server, the first set of instructions limiting the set of third party mobile devices to a geographic location.

4. The method of claim 1, wherein a second set of instructions are provided by the first mobile device when transmitting the electronic message to the remote media computer server, the second set of instructions directing the remote media computer server to transmit the electronic message to the author of the e-book content.

5. The method of claim 1, further comprising receiving and causing to display the electronic message using the display module on at least one of the third party mobile devices.

6. The method of claim 1, further comprising storing the electronic message, associated identification information of the first user mobile device, and the e-book identifier on the remote media computer server.

7. The method of claim 1, further comprising storing the electronic message on a storage device of the first user mobile device and a storage device on at least one of each of the third party mobile devices.

8. The method of claim 7, wherein the storage device on the first user mobile device and the third party user devices can be selected from a group consisting of at least one of an internal storage device and a removable storage device.

9. The method of claim 6, wherein the display module of the first user mobile device and the display module for the third party mobile devices are capable of presenting and hiding the information displayed on the respective mobile device.

10. The method of claim 1, further comprising:
generating a response electronic message by one of the third party mobile devices;
receiving the response electronic message by the remote media computer server;
transmitting, by the remote media computer server, the response electronic message to the first mobile device based on the associated identification information of the first mobile device;
receiving the response electronic message on the first user mobile device; and
displaying the response electronic message on the first user mobile device.

11. The method of claim 1, wherein the first user mobile device and the third party mobile devices can be selected from the group consisting of at least one of iPad, iPhone, Blackberry, Androids, Kindle, Nook, Sony Reader, BeBook Neo, and any other device that implements an electronic reading software program.

12. A system of interacting with digital media in an electronic book (e-book) reader using a remote network website, the system comprising:
a first user mobile device having:
a device display module configured to present e-book content on the display of the first mobile device using an electronic book reader application;
a device input module configured to receive input from the first user based on the e-book content on the first user mobile device through a user interface;
a device messaging module for generating at least one electronic message on the first user mobile device based on the input from the first user; and
a device communication module configured to transmit the electronic message, the associated identification information of the first user mobile device, and an e-book content identifier to a remote media computer server through a communication network.

13. The system of claim 12, further comprising:
a remote media computer server having:
a server communication module configured to receive the electronic message, associated identification information of the first user mobile device, and the e-book content identifier by the remote media computer server; and
a server processing module configured to determine a set of third party mobile devices having the e-book content based on the e-book content identifier;
wherein the server communication module transmits the electronic message to each of the third party mobile devices to be presented on the display of each third party mobile device.

14. The system of claim 13, wherein a first set of instructions are provided by the first mobile device when transmitting the electronic message to the remote media computer server, the first set of instructions limiting the set of third party mobile devices to a geographic location.

15. The system of claim 13, wherein a second set of instructions are provided by the first mobile device when transmitting the electronic message to the remote media computer server, the second set of instructions directing the remote media computer server to transmit the electronic message to the author of the e-book content.

16. The system of claim 12, further comprising a server storage module configured to store the electronic message, associated identification information of the first user mobile device, and the e-book content identifier on the remote media computer server.

17. The system of claim 12, wherein the first user device display module is capable of presenting and hiding the information displayed on the first user mobile device.

18. The system of claim 13, further comprising:
a third party mobile device having:
a third party device communication module configured to receive the electronic message from the remote media computer server;
a third party device input module configured to receive input from a third party user based on the electronic message through a user interface; and
a third party device messaging module for generating a response electronic message;
wherein a third party device communication module configured to transmit the response electronic message to the remote media computer server.

19. The system of claim 18, wherein:
the server communication module configured to receive the response electronic message from the third party user mobile device;
a server storage module to store the response electronic message generated by the third party mobile device; and
the server communication module configured to transmit the response electronic message by a third party user to the first user mobile device associated identification information of the first user mobile device.

20. The system of claim 19, wherein:
the device communication module configured to receive the response electronic message on the mobile device of the first user;
the device storage module configured to store the response electronic message on the first user mobile device of the first user; and
device display module configured to display the response electronic message on the first user mobile device.

21. The system of claim 18, further comprising a first user device storage module to store the electronic message on the first user mobile device and a third party device storage module to store the electronic message on each of the third party mobile devices.

22. The system of claim 18, wherein the first user device storage module and the third party device storage modules each can be selected from the group consisting of an internal storage device or a removable storage device.

23. A server for interacting with digital media in an electronic book (e-book) reader, the server comprising:
a server communication module configured to receive the electronic message, associated identification information of the first user mobile device, and the e-book content identifier by the remote media computer server; and
a server processing module configured to determine a set of third party mobile devices having the e-book content based on the e-book content identifier;
wherein the server communication module transmits the electronic message to each of the third party mobile devices to be presented on the display of each third party mobile device.

24. The server of claim 23, further comprising a server storage module configured to store the electronic message, associated identification information of the first user mobile device, and the e-book content identifier on the remote media computer server.

25. The server of claim 23, wherein the server communication module receives a first set of instructions from the first mobile device, the first set of instructions limiting the set of third party mobile devices to a geographic location.

26. The server of claim 23, wherein the server communication module receives a second set of instructions from the first mobile device, the second set of instructions directing the server to transmit the electronic message to the author of the e-book content.

27. The server of claim 23, wherein:
the server communication module configured to receive the response electronic message from the third party user mobile device; and
a server storage module to store the response electronic message generated by the third party mobile device;
the server communication module configured to transmit the response electronic message by a third party user to the first user mobile device based on the associated identification information of the first user mobile device.
